(19) United States
(12) Patent Application Publication
(10) Pub. No.: US 2004/0111505 A1
(43) Pub. Date: Jun. 10, 2004

(54) Method, system, and article of manufacture for network management

(75) Inventors: Tony L. Callahan, Westminister, CO (US); Robert J. Lecoq, Broomfield, CO (US); Daniel J. Maslowski, Erie, CO (US)

Correspondence Address: KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/315,794

(22) Filed: Dec. 10, 2002

(51) Int. Cl. G06F 15/173

(52) U.S. Cl. 709/223

(57) ABSTRACT

Provided are a method, system and article of manufacture for network management. Information is discovered on at least one client of a plurality of clients managed by a server. The discovered information is compared to rules related to the management of the plurality of clients, wherein the rules are for examining prior operational history and current operation of the at least one client. Based on the comparison, an update is recognized to be applied to the at least one client, wherein the update includes an executable that can be automatically installed on the at least one client. The update is pushed to the at least one client, wherein the discovering, comparing, recognizing and pushing are controlled by the server.

### BACKGROUND OF THE INVENTION

1. Field of the Invention

The present invention relates to a method, system, and an article of manufacture for network management.

2. Description of the Related Art

A computational device, such as a network connected client computer, may require updates. The updates may include new versions of applications, software patches, updates of data, etc. The updates may be available to the client from a server connected to the network. In prior art such updates may be initiated by the client and may be downloaded by the client from the server.

A user may install the downloaded updates on the client via manual processes that may involve significant administration and overhead. For example, a user may download a file via FTP (file transfer protocol) from a server, and then run an install command on the downloaded file to install a patch contained in the file. In prior art, after downloading the updates the client may also install the downloaded updates via automated processes that do not require any additional manual intervention by the user.

In one scenario, the client sends a request to the server for the update and in response receives the update from the server. In another scenario, the server may send a request to the client, where the request asks the client whether or not the client wants an update. The client may respond affirmatively to the request by the server and a process may pull the update from the server to the client. In either of the above scenarios, the permission for updating the client is initiated by the client. The above are pull models for updating the client because the client initiates the pulling of the desired update from the server over the network.

Notwithstanding present techniques for updating a client there is a need in the art for improved implementations for updating clients over a network via a server.

### SUMMARY OF THE PREFERRED EMBODIMENTS

Provided are a method, system and article of manufacture for network management. Information is discovered on at least one client of a plurality of clients managed by a server. The discovered information is compared to rules related to the management of the plurality of clients, wherein the rules are for examining prior operational history and current operation of the at least one client. Based on the comparison, an update is recognized to be applied to the at least one client, wherein the update includes an executable that can be automatically installed on the at least one client. The update is pushed to the at least one client, wherein the discovering, comparing, recognizing and pushing are controlled by the server.

Provided also are a method, system and article of manufacture for aggregating transactions. Data is received at a server on a plurality of transactions performed by clients managed to the server. A verification is made that the plurality of transactions conform to rules maintained at the server, wherein the rules are for examining prior operational history and current operation of the clients. The data on the plurality of transactions is aggregated at the server. The data on the plurality of transactions is sent to a master server coupled to the server, wherein the master server is a computational device coupled to a plurality of servers.

Provided also are a method, system and article of manufacture for updating devices. An update is received at a management server from a master server connected to the management server, wherein a plurality of management servers are connected to the master server. At least one client that requires the update is determined at the management server, wherein the one management server manages a plurality of clients including the at least one client, wherein the management server includes rules for examining prior operational history and current operation of the at least one client, and wherein the update including code is necessary for satisfying the rules. The update is pushed to the at least one client from the management server.

The implementations allow a management server to push information to a plurality of hosts connected to the management server. A plurality of such management servers may be connected to a master server. Information is propagated from the master server to the plurality of management servers and the management servers push the information to a plurality of hosts. The management server provides a single point of contact for all hosts connected to the management server. The single point of contact reduces the likelihood of errors when hosts are updated.

### BRIEF DESCRIPTION OF THE DRAWINGS

Referring now to the drawings in which like reference numbers represent corresponding parts throughout:

FIG. 1 illustrates a block diagram of a computing environment, in accordance with certain described aspects of the invention;

FIG. 2 illustrates a block diagram of a management server and a master server, in accordance with certain described implementations of the invention;

FIG. 3 illustrates a block diagram of a management transport agent and associated data structures, in accordance with certain described implementations of the invention;

FIG. 4 illustrates a block diagram of a management discovery agent and associated data structures, in accordance with certain described implementations of the invention;

FIG. 5 illustrates a block diagram of a management analysis agent and associated data structures, in accordance with certain described implementations of the invention;

FIG. 6 illustrates a block diagram of a management user interface agent and associated data structures, in accordance with certain described implementations of the invention;

FIG. 7 illustrates via a block diagram of a management billing and tracking agent, and associated data structures, in accordance with certain described implementations of the invention;

FIG. 8 illustrates logic for updating hosts, in accordance with certain described implementations of the invention;

FIG. 9 illustrates logic for pushing updates to a host, in accordance with certain described implementations of the invention;

FIG. 10 illustrates logic for aggregating billing information, in accordance with certain described implementations of the invention; and

FIG. 11 illustrates a block diagram of a computer architecture in which certain described aspects of the invention are implemented.

### DETAILED DESCRIPTION OF THE PREFERRED EMBODIMENTS

In the following description, reference is made to the accompanying drawings which form a part hereof and which illustrate several implementations. It is understood that other implementations may be utilized and structural and operational changes may be made without departing from the scope of the present implementations.

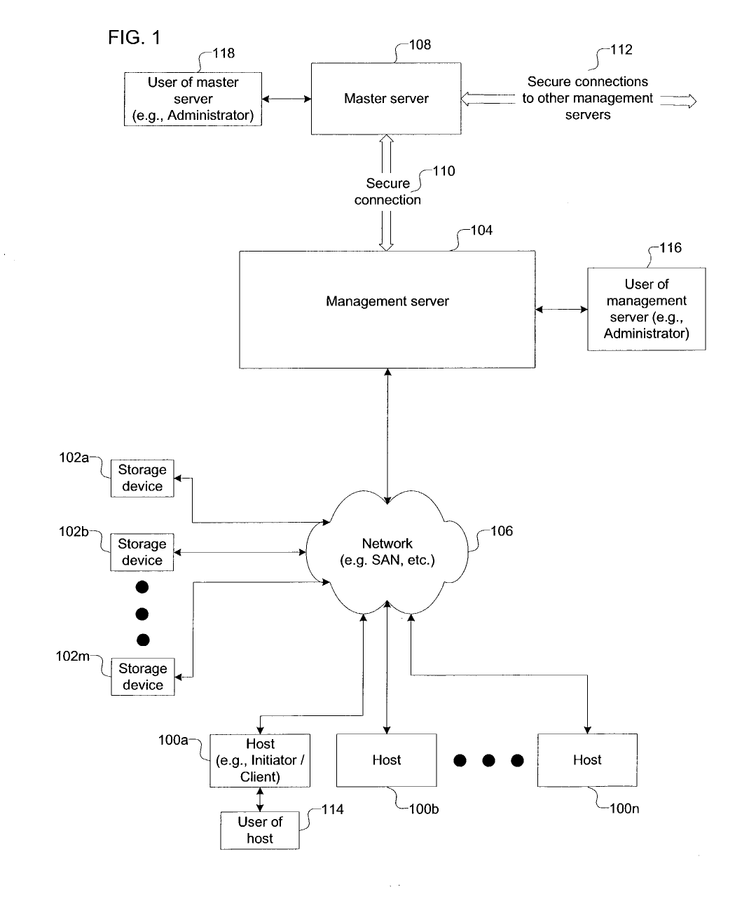

FIG. 1 illustrates a block diagram of a computing environment, in accordance with certain described aspects of the invention. A plurality of hosts 100a . . . 100n, a plurality of storage devices 102a . . . 102m, and a management server 104 are connected to a network 106, such as a storage area network.

The management server 104 may manage the hosts 100a . . . 100n and the plurality of storage devices 102a . . . 102m. The management server 104 may also be responsible for the configuration and management of volumes associated with the storage devices 102a . . . 102n. The management server 104 maintains the state and configuration for the system of hosts 110a . . . 100n and storage devices 102a . . . 102n connected to the network 106

The implementations allow the management server 104 to push information to the plurality of hosts 100a . . . 100n. The pushed information may update the plurality of hosts 100a . . . 100n. Furthermore, the implementations allow the management server 104 to aggregate the accounting information related to the hosts 100a . . . 100n and the storage devices 102a . . . 102m. Therefore, the management server 104 provides centralized services for the plurality of hosts 100a . . . 100n and storage devices 102a . . . 102m. The hosts 100a . . . 100n may therefore function as clients to the management server 104 and may additionally act as initiators that initiate certain processes.

A master server 108 is connected to the management server 104 via a secure connection 110. The master server 108 may be also be connected to a plurality of other management servers besides management server 104, via secure connections 112. The master server 108 may control and coordinate a plurality of management servers, such as the management server 104.

The hosts 100a . . . 100n, the management server 104, and the master server 108 may be any computational device known in the art, such as a personal computer, a workstation, a server, a mainframe, a hand held computer, a palm top computer, a telephony device, a network appliance, etc. The network 106 may be any network known in the art, such as the Internet, an intranet, a Local area network (LAN), a Storage area network (SAN), a Wide area network (WAN), a wireless network, etc. The management server 104 may alternatively be connected to the hosts 100a . . . 100n and the storage devices 102a . . . 102m without a network, such as through direct lines, common bus systems etc., in a manner known in the art. Also the network 106 may be part of one or more larger networks or may be an independent network or may be comprised of multiple interconnected networks. The plurality of storage devices 102 . . . 102m may include disk storage devices, tape storage devices or any other storage devices known in the art.

While in the described implementations, the hosts 102a . . . 102n and the management server 104 communicate within a client-server paradigm, with the hosts 102a . . . 102n acting as clients and the management server 104 acting as a server, the hosts 102a . . . 102n and the management server 104 may also communicate within a peer-to-peer or other paradigm known in the art. Similarly, while the management server 104 and the master server 108 communicate within a client-server paradigm, with the management server 104 acting as a client and the master server 108 acting as the server in the described implementations, the management server 104 and the master server 108 may also communicate within a peer-to-peer or other network paradigm known in the art.

Also indicated in FIG. 1 is a representative user 114 of the host 100a, a representative user 116 of the management server 104, and a representative user 118 of the master server 108. In certain situations the users may be administrators. The users 114, 116, 118 may control the host 100a, the management server 104, and the master server 108 respectively by interacting via graphical user interfaces or command line interfaces.

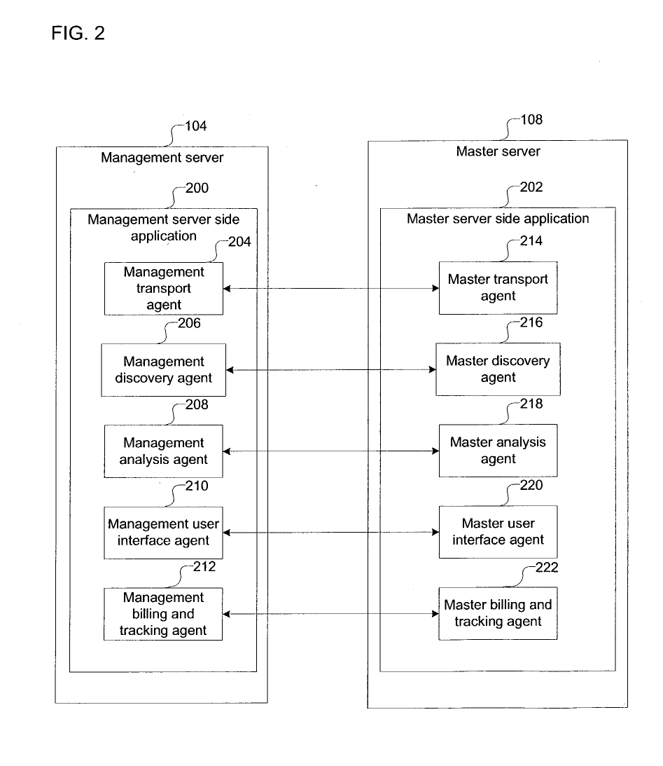

FIG. 2 illustrates a block diagram of the management server 104 and the master server 108, in accordance with certain described implementations of the invention.

The management server 104 includes a management server side application 200 and the master server 108 includes a master server side application 202. The master server side application 202 manages the hosts 100a . . . 100n and the storage devices 102a . . . 102m. The master server side application 202 may control and coordinate a plurality of management server side applications, such as the management server side application 200, on a plurality of management servers, including the management server 104. The management server side application 200 and the master server side application 202 may each be a single application or a collection of applications and may be written in any programming language known in the art.

In certain implementations of the invention, the management server side application 200 includes a management transport agent 204, a management discovery agent 206, an management analysis agent 208, a management user interface agent 210, and a management billing and tracking agent 212. Corresponding to the transport agent 205, the management discovery agent 206, the management analysis agent 208, the management user interface agent 210, and the management billing and tracking agent 212 there may be a master transport agent 214, a master discovery agent 216, a master analysis agent 218, a master user interface agent 220 and a master billing and tracking agent 222 respectively on the master server 108. The agents 200, 204, 206, 208, 210, 212, 214, 216, 218 may be implemented as applications or as objects within applications.

The management transport agent 204 fetches and stores information in computer readable format for the management server 104 and the master transport agent 214 fetches and stores information in computer readable format for the master server 108. For example, the management transport agent 204 may fetch billing and tracking information and determine whether an invoice has been paid or is pending and store the information in the management server 104. The master transport agent 214 may control and coordinate a plurality of management transport agents, including the management transport agent 204, on a plurality of management servers, including the management server 104.

The management discovery agent 206 is responsible for the discovery of the infrastructure, including the hosts 100a . . . 100n, the storage devices 102a . . . 102m, that the management server 104 is connected to. The master discovery agent 216 is responsible for the discovery of the infrastructure, including the management servers 104, etc., that the master server 108 is connected to. The master discovery agent 216 may control and coordinate a plurality of management discovery agents, including the management discovery agent 206, on a plurality of management servers, including the management server 104.

The management analysis agent 208 is responsible for validating a set of business rules for the system comprised of the hosts 100a . . . 100n, the storage devices 102a . . . 102n, and the management server 104 connected over the network 106. The master analysis agent 218 is responsible for validating a set of business rules for the system comprised of the master server 108 and the management servers, including the management server 104, connected to the master server 108 via the secure connections 110, 112. The master analysis agent 218 may control and coordinate a plurality of management analysis agents, including the management analysis agent 208, on a plurality of management servers, including the management server 104. The business rules may include accounting and billing information and licensing rules for the system. The business rules may also include rules related to examining the historical and present operation of the system.

The management user interface agent 210 is responsible for presenting information in a human readable form to the users of hosts 100a . . . 100n, including the user 114. The master user interface agent 220 is responsible for presenting information in a human readable format to the users of management servers, such as the user 116. The master user interface agent 218 may control and coordinate a plurality of management user interface agents, including the user interface agent 208, on a plurality of management servers, including the management server 104.

The management billing and tracking agent 212 is responsible for the billing and tracking of transactions for hosts 100a . . . 100n and storage devices 102a . . . 102m connected to the network 106. The master billing and tracking agent 222 controls and coordinates one or more management billing and tracking agents, including the management billing and tracking agent 212, that are to be found in management servers, including the management server 104, connected to the master server 108.

In certain implementations of the invention, the master server 108 manages a plurality of management servers, including management server 104. Each management server manages a plurality of devices, including hosts and storage devices. A management server, such as management server 104, may discover new devices, in addition to discovering devices existing on the network. On discovering devices the management server may determine whether the software, hardware and firmware on the devices conform to certain business rules. The business rules may include rules related to checking whether the devices have correct versions of software, rules related to determining whether the users of the devices have been charged appropriately for services provided to the users via the devices, rules related to determining whether the logs kept in the devices include any entries that should not be present, rules related to licensing requirements, etc., The business rules may also include rules related to the overall operation of the network connecting the management server to the devices, such as the version and connectivity characteristics of the network and related software. The business rules are for examining prior operational history and current operation of the hosts 100a . . . 100n, and may include rules for analyzing log files.

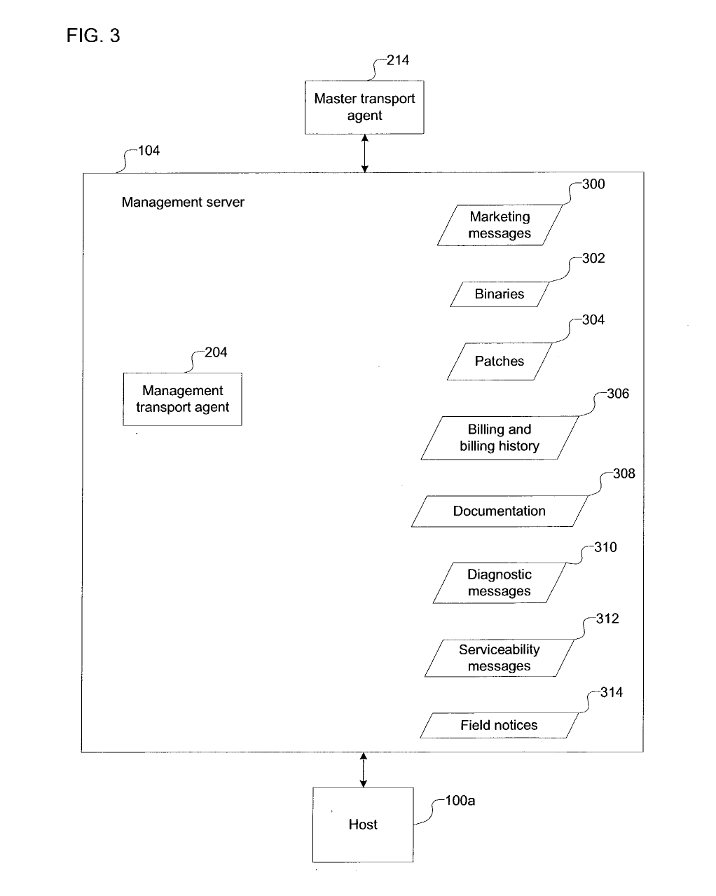

FIG. 3 illustrates a block diagram indicating the interactions between the management transport agent 204, the master transport agent 214, and the host 100a in accordance with certain described implementations of the invention.

The management transport agent 204 may deliver or exchange information such as marketing messages 300, binaries 302, patches 304, billing and billing history 306, documentation 308, diagnostic messages 310, serviceability messages 312, field notices 314, etc., with the master transport agent 214 and the host 100a. Marketing messages 300 may include promotional material for advertising new and upcoming software or software upgrades, advertisements for products or services, etc. Binaries 302 may include new software modules and patches 304 may includes software updates that rectify defects in existing software. The billing and billing history 306 may include the aggregated billing information for the hosts 100a . . . 100n and storage devices 102a . . . 102m managed by the management server 104. The diagnostic messages 310 may includes messages involving system or network diagnostics or any other diagnostics known in the art. The serviceability messages 312 may include messages involving serviceability of software, hardware, etc. The field notices 314 may include any type of field notices known in the art that are appropriate for the management transport agent 204 and the master transport agent 214.

While only one host 100a is shown, the management transport agent 204 may deliver or exchange information with a plurality of hosts 100a . . . 100n. For example, management transport agent 204 may deliver information, such as a patch 304, that is necessary for updating software on hosts 100a . . . 100n connected to the management server 104. The same patch 304 may be made available to a plurality of hosts, including host 100a.

While only one management transport agent 204 is shown the master transport agent 214 may deliver or exchange information with a plurality of management transport agents 204 located on a plurality of management servers, including the management server 104. For example, master transport agent 214 may send information, such as the patch 304, that is necessary for updating software on hosts 100a . . . 100n connected to the management server 104. The same patch 304 may be made available by the master transport agent 214 to to other management servers besides management server 104. Thus the master transport agent 214 is a central repository and controlling agent for a plurality of management transport agents 204.

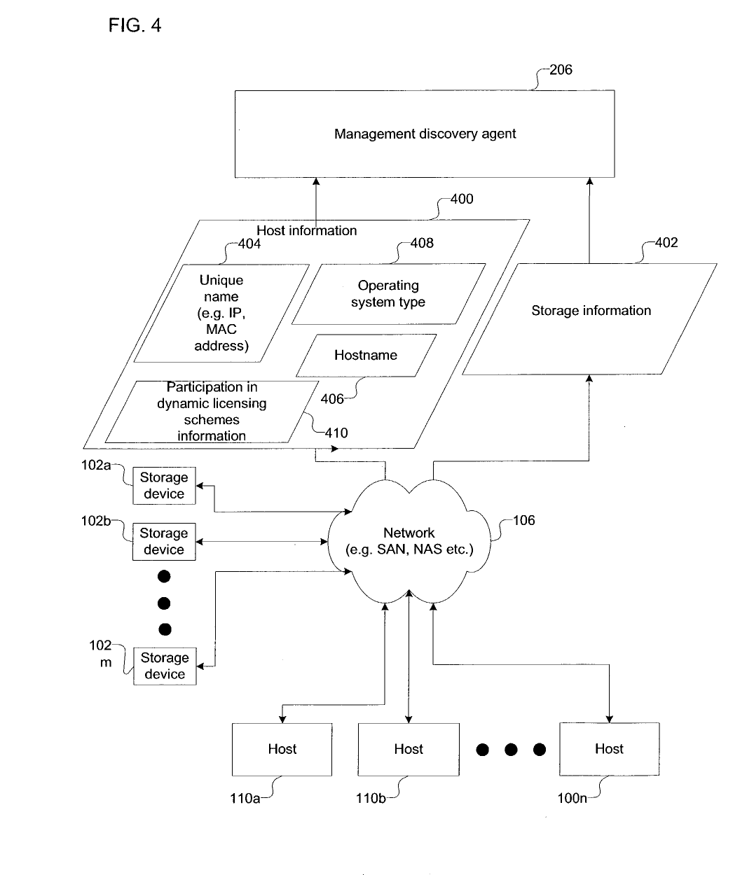

FIG. 4 illustrates a block diagram of a management discovery agent 206, indicating the interactions of the management discovery agent 206, in accordance with certain described implementations of the invention. The management discovery agent 206 is responsible for the discovery of the components of the system connected to the network 106. The management discovery agent 206 sends queries across the network 106 and discovers hosts 100a . . . 100n and storage devices 102a . . . 102m and may secure host information 400 and storage information 402 in a manner known in the art. The management discovery agent 206 may also discover transport and bridging devices connected to the network 106.

The host information 400 for a host, such as host 100a, may include a unique name 404, such as an IP (Internet Protocol) or MAC (Media Access Control) address. The host information 400 may also include a hostname 406 for the host 100a and the operating system type 408 for the host 100a. Other host related information may also be discovered from the hosts 100a . . . 100n by the management discovery agent 206, such as information exported by hosts 100a . . . 100n including participation in dynamic licensing schemes information 410. For example, the host 100a may have a license to use a word processing program based on a dynamic license granted by the management server 104 and such information may be included in the participation in dynamic licensing schemes information 410. The storage information 402 may include the unique names, type of storage device 102a . . . 102m, and the total amount of available storage on the storage device 102a . . . 102m, etc.

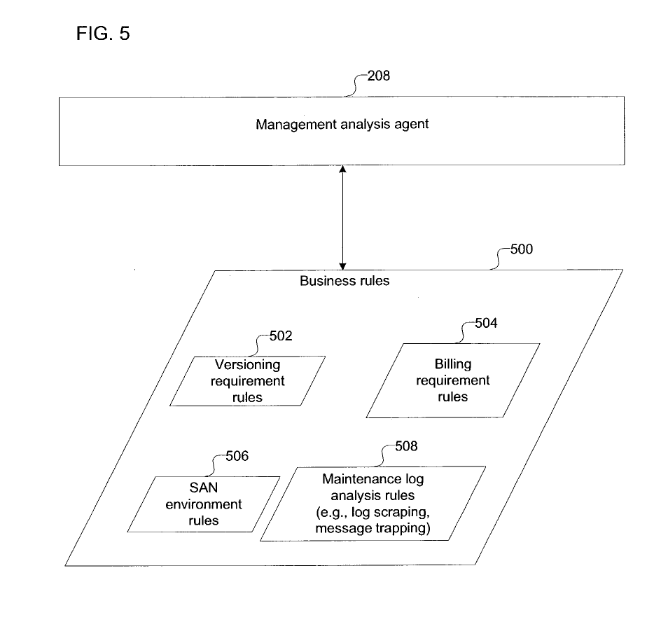

FIG. 5 illustrates a block diagram of the management analysis agent 208, in accordance with certain described implementations of the invention. The management analysis agent 208 is responsible for validating a set of business rules 500 for the system comprised by the hosts 100a . . . 100n, the storage devices 102a . . . 102n, and the management server 104 connected over the network 106. The business rules may relate to business and accounting aspects of the network managed by the management server 104 and may relate rules examining the prior and current operation of the client.

The business rules analyzed by the management analysis agent 208 may include versioning requirement rules 502, billing requirement rules 504, SAN environment rules 506 and maintenance log analysis rules 508. The maintenance log analysis rules 508 may allow the past operation of the be checked against all the business rules 500. Log files maintained at the hosts 100a . . . 100n that indicate the operational history of the hosts 100a . . . 100n may be compared with the maintenance log analysis rules 508. In certain implementations if the hosts 100a . . . 100n have performed some unauthorized tasks or have exhibited behavior that was not detected as unusual at the time the tasks took place, such tasks or behavior may subsequently be examined by comparing with the maintenance log analysis rules 508 at a later time. As an example of the rules, the versioning requirement rule 502 may require that all hosts 100a . . . 100n connected to the network 106 must have version 4.0 or higher versions of a particular operating system. In such a case the management analysis agent 208 may validate that hosts 100a . . . 100n conform to the versioning requirements rule 502. The SAN environment rules 506 may require a particular version of SAN. Other business rules (not shown) may indicate that hosts 100a . . . 100n with software that may potentially cause the network 106 to malfunction be shut down by the management server 104.

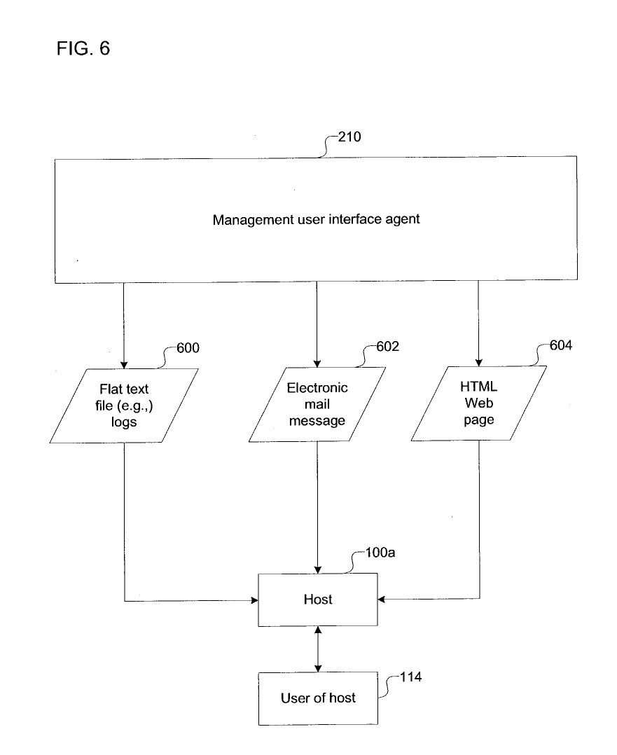

FIG. 6 illustrates a block diagram of the management user interface agent 210 interacting with the representative host 100a, in accordance with certain described implementations of the invention. The management user interface agent 210 is responsible for presenting information in a human readable form to the users of hosts 100a . . . 100n, such as the user 114.

The information presented by the management user interface agent 210 may include flat text file 600 (e.g., log files), electronic mail messages 602, an HTML web page 604, etc. The user interface agent 100 presents the information to the representative host 100a and the user 114 makes use of the presented information. The management user interface agent 210 presents the information in any manner known in the art including via a graphical user interface on the host 100a. The user 114 may indicate preferences on the way in which he wants the information to be presented by the management user interface agent 210 for viewing. However, It is not necessary for all the information presented by the management user interface agent 210 to be viewable. Some information may be stored in host 100a for use by system programs or application, and may even be stored in an encrypted format that is not viewable by the user 114.

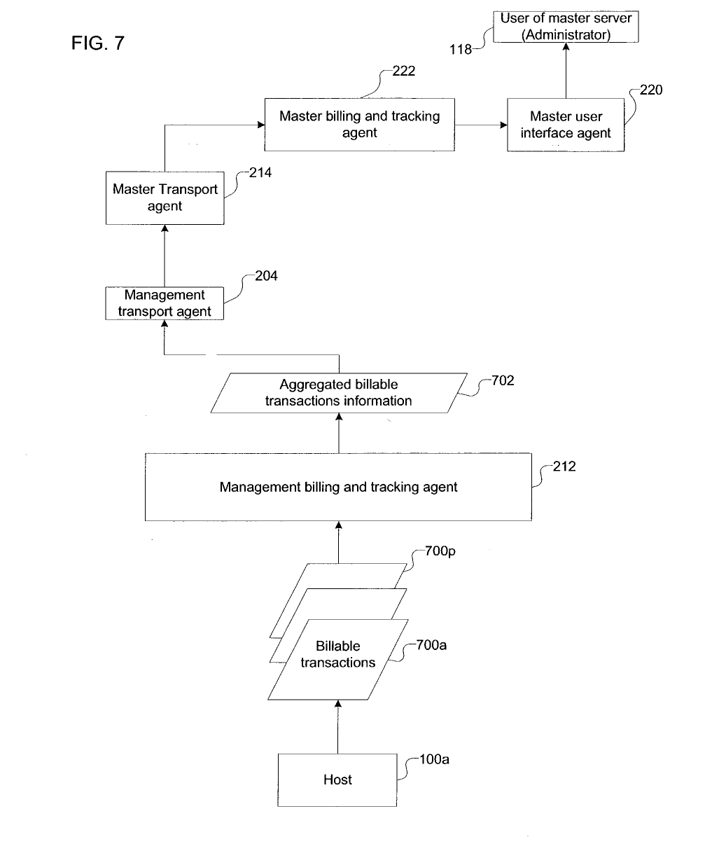

FIG. 7 illustrates in a block diagram interactions of the billing and analysis agent 212, in accordance with certain described implementations of the invention. A representative host 100a may generate a plurality of billable transactions 700a . . . 700p over a period of time. The billable transactions 700a . . . 700p may include access by the host 100a to certain databases on the management server 104 or usage changes for certain software programs as monitored by the management server 104.

The management billing and tracking agent 212 aggregates the plurality of billable transactions 700a . . . 700p into an aggregated billable transactions information 702. The aggregated billable transactions information 702 may include the plurality of billable transactions 700a . . . 700n in some ordered sequence, such as a sequence ordered by the time of the transactions. During aggregation the management billing and tracking agent 212 may determine the total charge for the plurality of billable transactions 700a . . . 700p and include the total charge in the aggregated billable transactions information 702 in an invoice.

The management transport agent 204 on the management server 104 may send the aggregated billable transactions information to the master transport agent 214 on the master server 108. The master billing and tracking agent 222 may receive the aggregated billing and transactions information 722 and send the information to the master user interface agent 220 for display to the user 118 of master server 108.

Therefore, the management billing and tracking agent 212 on the management server 104 may aggregate the billing information for a plurality of hosts 100a . . . 100n. The master billing and tracking agent 222 has access to the aggregated billable transactions information 702 for a plurality of management servers, including management server 104. The user 118 of master server 108, who is typically a system administrator, can therefore have access to the billing formation on a plurality of management servers 104 that are subordinate to the master server 108.

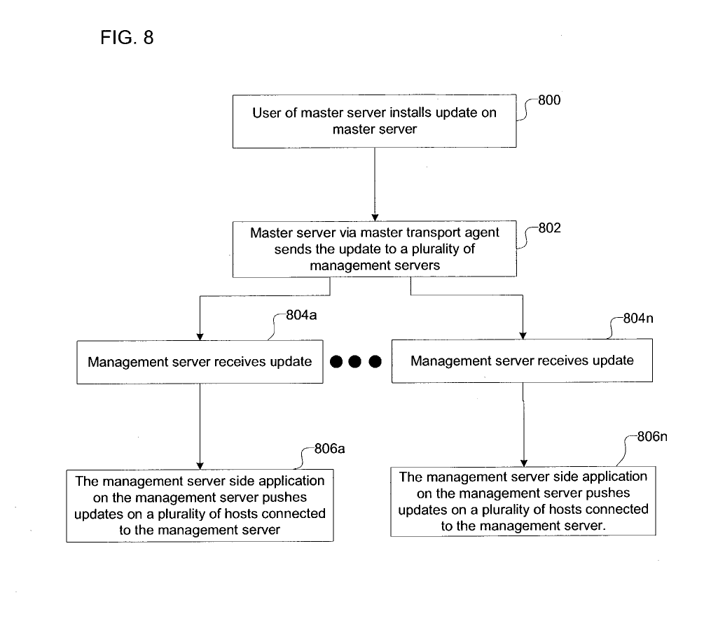

FIG. 8 illustrates logic for updating hosts 100a . . . 100n, in accordance with certain described implementations of the invention. The logic of FIG. 8 is performed in part by the master server side application 202 on the master server 108 and in part by the management server side application 200 on the management server 104.

Control starts at block 800, where the user 118 of master server 108 installs an update on the master server 108. The update installed may include marketing messages 300, binaries 302, patches 304, documentation 308, etc. The installation of the update on the master server 108 may be performed in any manner known in the art, such as via a CDROM, a floppy diskette, etc.

Control proceeds to block 802 where the master transport agent 214 on the master server 108 sends the update to a plurality of management servers, including the management server 104, over the secure connections 110, 112. Therefore, the master transport agent 214 distributes the update to a plurality of management servers. For example, a patch may be transmitted to a plurality of management servers.

Control proceeds to block 804a . . . 804n where the management servers, including management server 104, receives the update. Control proceeds to block 806a . . . 806n where the management server side application, such as the management server side application 204 on the management server 104, installs the update on the hosts, such as hosts 100a . . . 100n.

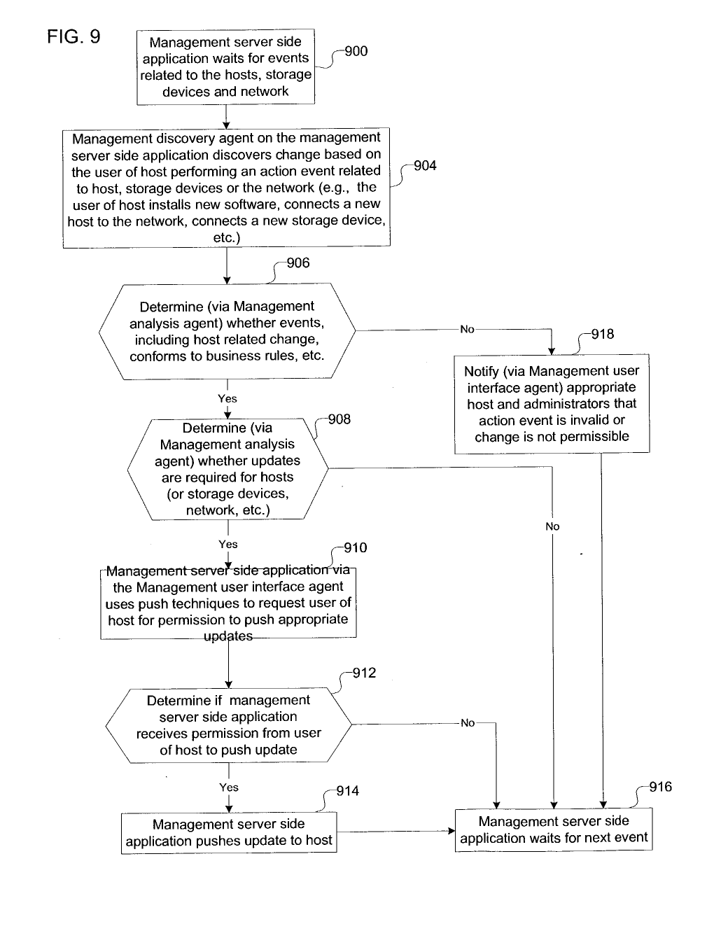

Therefore, in the logic described in FIG. 9 an update on a master server 108 is propagated to a plurality of management servers that push the update to hosts connected to the management servers.

FIG. 9 illustrates logic implemented in the management server side application 200 for pushing updates to the hosts 10a . . . 100n from the management server 104, in accordance with certain described implementations of the invention. Other managements servers push updates to hosts in a corresponding manner.

Control starts at block 900, where the management server side application 200 waits for events related to the hosts 100a . . . 100n, the storage devices 102a . . . 102m, and the network 106. Such events may include a new host or storage device being added to the network or any other event that changes the behavior or configuration of the network 106 and the associated components in a manner known in the art.

Control proceeds to block 904, where the management discovery agent 206 on the management server side application discovers a change in the state of the network 106 or the components connected to the network 106, such as the hosts 100a . . . 100n or the storage devices 102a . . . 102n. For example, the user 114 may have installed a new software on the host 102a or may have connected a new host or a storage device to the network 106 to change the state of the network 106. In one implementation of the invention, the user 114 may have attached a new host running the Solaris** operating system to the network 106 and indicated to the new host that the management server 104 is the server responsible for managing the new host. The management discovery agent 206 discovers the change in the state of the network 106. For example, if a new host is added by the user 114, the management discovery agent 206 may discover the unique name 404, the operating system type 408 and the hostname 406 of the new host. ** Solaris is a trademark of Sun Microsystems, Inc.

Control proceeds to block 906, where the management analysis agent 208 determines whether the event detected by the management discovery agent 206 conforms to the business rules 500. Conformance to the business rules 500 is determined without any explicit additional action by the hosts 100a . . . 100n. The business rules 500 may include rules related to checking whether hosts 100a . . . 100n connected to the management server 104 have correct versions of software, rules related to determining whether the users of the hosts 100a . . . 100n have been charged appropriately for services provided to the users via the hosts 100a . . . 100n, rules related to determining whether the logs kept in the hosts 100a . . . 100n include any entries that should not be present, rules related to licensing requirements, etc., The business rules 500 may also include rules related to the overall operation of the network connecting the management server to the hosts 100a . . . 100n, such as the version and connectivity characteristics of the network and related software. The business rules 500 may also allow the examination of log files maintained by the hosts 100a . . . 100n. Therefore, the business rules 500 can be checked against both the prior and current operation of the hosts 100a . . . 100n.

If so, control proceeds to block 908 where the management analysis agent 208 determines whether updates are required for the hosts 100a . . . 100n or storage devices 102a . . . 102m connected to the network 106. If so, control proceeds to block 910 where the management user interface agent 210 uses push techniques known in the art to display on the host 100a a request to the user 114 for permission to push appropriate updates. In certain implementations block 910 may be omitted and no requests for permission are sent to the user 114.

Control proceeds to block 912, where the management server side application 200 determines permission has been received from user 114 to push the update to the host 100a. If so, then at block 914 the management server side application 200 pushes the update to the host 100a. Control proceeds to block 916, where the management server side application 200 waits for the next event.

If at block 906, the management analysis agent 208 determines that the events do not conform to the business rules 500, then control proceeds to block 918 where the management user interface agent 210 notifies the appropriate host that the action even is invalid or that the change is not permissible. In certain implementations, a corrective action may also be indicated to the appropriate host. Additionally, the notification may also be sent to an administrator of the management server 104, such as the user 116 of the management server 104. For example, if a Linux operating system based personal computer is newly connected to the network 106 and the business rules 500 permit only computers based on the Solaris** operating system to be connected, then the user interface agent may notify the newly connected host that only the Solaris** operating system is permitted on the network 106. The administrator of the management server may be notified that a personal computer with an unauthorized operating system is attempting to connect to a Solaris** only storage area network. In certain situations options may be provided to the newly connected host to change the operating system via the management server and be charged for the change. Control proceeds to block 916, where the management server side application 200 waits for the next event. ** Solaris is a trademark of Sun Microsystems, Inc.

If at block 908 the management analysis agent 208 determines that no updates are required by the hosts 100a . . . 100n, then control proceeds to block 916, where the management server side application 200 waits for the next event.

If at block 912, the management server side application 200 does not receive permission of the user 114 to push updates then control proceeds to block 916, where the management server side application 200 waits for the next event.

The logic of FIG. 9 updates hosts 100a . . . 100n connected to the network 106 via push techniques from the management server 104. In certain alternative implementations of the invention no permission is necessary from the user 114 before updating the hosts 100a . . . 100n.

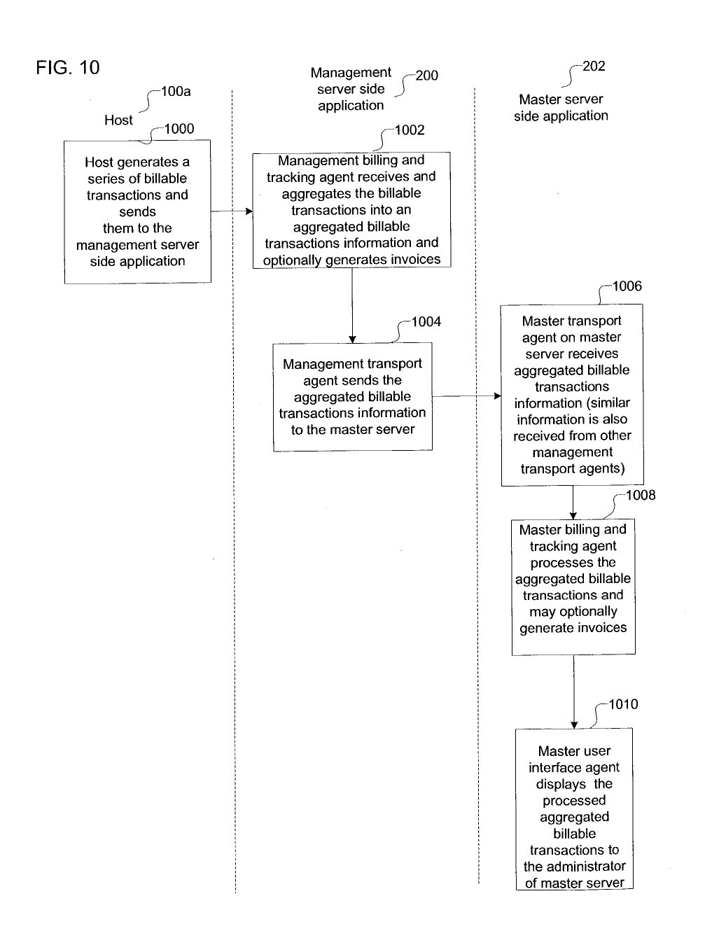

FIG. 10 illustrates logic for aggregating billing information, in accordance with certain described implementations of the invention. The logic is implemented in the host 100a, the management server side application 200 and the master server side application 202 as shown in FIG. 10.

Control starts at block 1000 where the hosts 100a . . . 100n, including host 100a, generates a series of billable transactions 700a . . . 700p. In implementations of the invention, the series of billable transactions may be generated by one host 100a or by a plurality of hosts 100a . . . 100n. The series of billable transactions 700a . . . 700p are sent to the management server side application 200.

Control proceeds to block 1002 where the management billing and tracking agent 212 in the management server side application 200 receives the series of billable transactions 700a . . . 700p. The series of billable transactions 700a . . . 700p may be received by the billing and tracking agent 712 in any order and need not be in the order in which the hosts, including 100a, send the transactions. The billing and tracking agent 712 aggregates the billable transactions into an aggregated billable transactions information 702. The billing and tracking agent may also generate appropriate invoices related to the aggregated billable transactions information for the user 114 of the host 100 or for any other users.

Control proceeds to block 1004 where the management transport agent 204 on the management server 104 sends the aggregated billable transactions information 702 to the master server 108. The master transport agent 214 on the master server 108 receives (at block 1006) the aggregated billable transactions information 702. In implementations of the invention the master transport agent 214 may receive aggregated billable transactions information 702 from a plurality of management transport agents, including management transport agent 204, located in a plurality of management servers 104.

Control proceeds to block 1008 where the master billing and tracking agent 222 processes the aggregated billable transactions information 702. The processing may include aggregating and generating reports related to a plurality of management servers, including management server 104. Control proceeds to block 1010 where the master user interface agent 220 displays the processed aggregated billable transactions to the user 118 of master server 108.

The described implementations allow a management server to push information such as software updates to a plurality of hosts connected to the management server. A plurality of such management servers may be connected securely to a master server that can be a central repository of software updates and other information. Therefore, information is propagated from a master server to a plurality of management servers and the management servers push the information to a plurality of hosts. As a result, the hosts may avoid pulling information one by one from the corresponding management server. The implementations allow the management server to push information to a plurality of hosts simultaneously thereby reducing the likelihood of errors when compared to the situation where the information is pulled either manually or automatically by the plurality of hosts.

The described implementations assigns the tasks performed by the management server into a number of modular agents such as a transport agent, a discovery agent, an analysis agent, an user interface agent and a billing and tracking agent. Corresponding to such agents are associated agents located at a master server that may control the agents on a plurality of management servers. The hierarchical control mechanism facilitates distribution of information across a plurality of networks.

From the perspective of the hosts the management server managing the hosts is the repository for all updates that are necessary. Thus the management server provides a single point of contact for all hosts connected to the management server. The single point of contact reduces the likelihood of errors when hosts are updated.

The described implementations also allow a billing and tracking agent on the management server to aggregate billing and tracking information for a plurality of hosts. The aggregated billing and tracking information of a plurality of management servers may be further processed at a master server. Therefore, the described implementations provide improved billing and tracking for a plurality of hosts and storage devices connected to networks.

### Additional Implementation Details

The described techniques may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium, such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the implementations, and that the article of manufacture may comprise any information bearing medium known in the art.

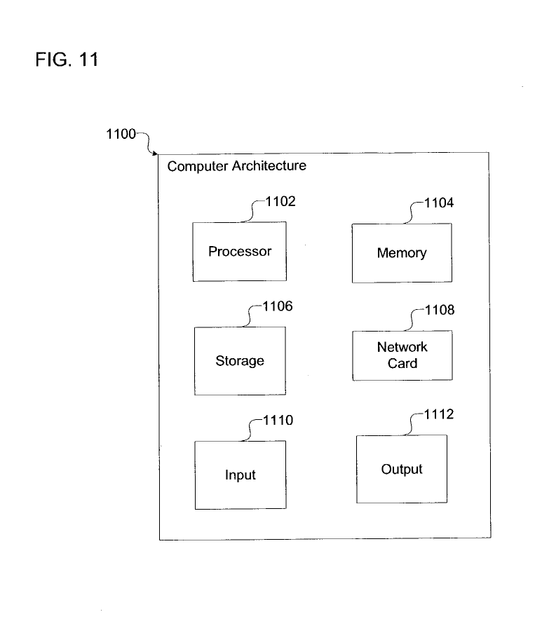

FIG. 11 illustrates a block diagram of a computer architecture in which certain aspects of the invention are implemented. FIG. 11 illustrates one implementation of the hosts 100a . . . 100n, the management server 104 and the master server 108. The hosts 100a . . . 100n, the management server 104 and the master server may implement a computer architecture 1100 having a processor 1102, a memory 1104 (e.g., a volatile memory device), and storage 1106 (e.g., a non-volatile storage, magnetic disk drives, optical disk drives, tape drives, etc.). The storage 1106 may comprise an internal storage device, an attached storage device or a network accessible storage device. Programs in the storage 1106 may be loaded into the memory 1104 and executed by the processor 1102 in a manner known in the art. The architecture may further include a network card 1108 to enable communication with a network. The architecture may also include at least one input 1110, such as a keyboard, a touchscreen, a pen, voice-activated input, etc., and at least one output 1112, such as a display device, a speaker, a printer, etc.

The logic of FIGS. 8-10 describe specific operations occurring in a particular order. Further, the operations may be performed in parallel as well as sequentially. In alternative implementations, certain of the logic operations may be performed in a different order, modified or removed and still implement implementations of the present invention. Morever, steps may be added to the above described logic and still conform to the implementations. Yet further steps may be performed by a single process or distributed processes.

While the hosts 100a . . . 100n and the management server 104 communicate within a client-server paradigm in the described implementations, hosts 100a . . . 100n and the management server 104 the may also communicate within a peer-to-peer or any other paradigm known in the art. Similarly the management server 104 and the master server 108 may communicate in any paradigm known in the art. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures, applications, agents, and components shows in FIGS. 1-8 are shown as having specific types of information. In alternative implementations, the data structures, agents, and components may be structured differently and have fewer, more or different fields, components or functions than shown in the figures.

Therefore, the foregoing description of the implementations has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

What is claimed is:

1. A method for network management comprising:
discovering information on at least one client of a plurality of clients managed by a server;
comparing the discovered information to rules related to the management of the plurality of clients, wherein the rules are for examining prior operational history and current operation of the at least one client;
based on the comparison, recognizing an update to be applied to the at least one client, wherein the update includes an executable that can be automatically installed on the at least one client; and
pushing the update to the at least one client, wherein the discovering, comparing, recognizing and pushing are controlled by the server.

2. The method of claim 1, wherein the discovering is performed by a discovery application on the server, wherein the discovering further comprises:
determining a unique name of the at least one client;
determining an operating system of the at least one client; and
determining a participation in a dynamic licensing scheme of the at least one client.

3. The method of claim 1, wherein the comparing and recognizing is performed by an analysis application on the server, and wherein the rules related to the management of the plurality of clients include rules related to versioning requirements of software, rules related to network environment, rules related to billing, rules related to analysis of logs, and rules related to licensing requirements.

4. The method of claim 1, wherein the server includes an user interface application, the method further comprising:
prior to pushing, displaying a message via the user interface application on a screen of the at least one client, wherein the message is transmitted in hypertext, text file format or electronic mail to the at least one client, and wherein the message requests permission from the at least one client for pushing the update.

5. The method of claim 1, further comprising:
prior to pushing the update, receiving the update at the server from a master server, wherein the master server is a computational device to which a plurality of servers are securely connected.

6. The method of claim 1, further comprising:
based on the comparison, determining that the at least one client cannot be managed by the server;
sending a notification to an user of the at least one client and the administrator of the server of the determination that the at least one client cannot be managed by the server; and
sending a suggested modification that would allow the at least one client to be managed by the server to the user of the at least one client.

7. The method of claim 1, wherein the discovering, comparing, recognizing, and pushing are performed by a server side application on the server, wherein the server side application comprises of:
a discovery application for performing discovery functions related to the plurality of clients;
an analysis application for performing validity checks with respect to the rules for the plurality of clients; and
an user interface application to control a display of information on the plurality of clients;

8. The method of claim 1, wherein the server is connected to a storage area network, and wherein the plurality of clients include hosts and storage devices.

9. A method for aggregating transactions comprising:
receiving at a server data on a plurality of transactions performed by clients managed to the server;
verifying that the plurality of transactions conform to rules maintained at the server, wherein the rules are for examining prior operational history and current operation of the clients;
aggregating at the server the data on the plurality of transactions; and
sending the data on the plurality of transactions to a master server coupled to the server, wherein the master server is a computational device coupled to a plurality of servers.

10. The method of claim 9, further comprising:
generating an invoice based on the aggregated data on the plurality of transactions; and
displaying the data on the plurality of transactions to an administrator connected to the server.

11. The method of claim 9, wherein the master server has master server side applications that corresponds to server side applications on the server, the method further comprising:
storing the data on the plurality of transactions at the master server; and
displaying the data on the plurality of transactions to an administrator connected to the master server.

12. The method of claim 9, wherein the data on the plurality of transactions include billing information related to the plurality of clients, and a billing application on the server performs the aggregating, wherein the billing application on the server sends the data to a master billing application on the at least one server.

13. A method for updating devices, comprising:
receiving an update at a management server from a master server connected to the management server, wherein a plurality of management servers are connected to the master server;
determining at the management server at least one client that requires the update, wherein the one management server manages a plurality of clients including the at least one client, wherein the management server includes rules for examining prior operational history and current operation of the at least one client, and wherein the update including code is necessary for satisfying the rules; and
pushing the update to the at least one client from the management server.

14. The method of claim 13, wherein the master server manages the plurality of management servers, wherein the master server is connected securely to the plurality of management servers, wherein the plurality of clients comprise a storage area network, and wherein pushing the update to the at least one client does not require permission of any user of the at least one client.

15. The method of claim 13, wherein the plurality of management servers periodically update the master server with information related to the plurality of clients managed by the plurality of management servers.

16. A system for network management of a plurality of clients comprising:
a server connected to the plurality of clients and managing the plurality of clients;
means for discovering information on at least one client of the plurality of clients;
means for comparing the discovered information to rules related to the management of the plurality of clients, wherein the rules are for examining prior operational history and current operation of the at least one client;
means for recognizing an update to be applied to the at least one client based on the comparison, wherein the update includes an executable that can be automatically installed on the at least one client; and
means for pushing the update to the at least one client, wherein the discovering, comparing, recognizing and pushing are controlled by the server.

17. The system of claim 16, wherein the means for discovering includes a discovery application on the server, wherein the means for discovering further performs:
determining a unique name of the at least one client;
determining an operating system of the at least one client; and
determining a participation in a dynamic licensing scheme of the at least one client.

18. The system of claim 16, wherein the means for comparing and the means for recognizing include an analysis application on the server, and wherein the rules related to the management of the plurality of clients include rules related to versioning requirements of software, rules related to network environment, rules related to billing, rules related to analysis of logs, and rules related to licensing requirements.

19. The system of claim 16, wherein the server includes an user interface application, the system further comprising:
means for displaying a message via the user interface application on a screen of the at least one client, wherein the message is transmitted in hypertext, text file format or electronic mail to the at least one client, and wherein the message requests permission from the at least one client for pushing the update.

20. The system of claim 16, further comprising:
means for receiving the update at the server from a master server, wherein the master server is a computational device to which a plurality of servers are securely connected.

21. The system of claim 16, further comprising:
means for determining that the at least one client cannot be managed by the server;
means for sending a notification to an user of the at least one client and the administrator of the server of the determination that the at least one client cannot be managed by the server; and
means for sending a suggested modification that would allow the at least one client to be managed by the server to the user of the at least one client.

22. The system of claim 16, wherein the means for discovering, the means for comparing, the means for recognizing, and the means for pushing comprise a server side application on the server, wherein the server side application comprises of:
a discovery application for performing discovery functions related to the plurality of clients;
an analysis application for performing validity checks with respect to the rules for the plurality of clients; and
an user interface application to control a display of information on the plurality of clients;

23. The system of claim 16, wherein the server is connected to a storage area network, and wherein the plurality of clients include hosts and storage devices.

24. A system for aggregating transactions from clients comprising:
a server coupled to the clients and managing the clients;
means for receiving at the server data on a plurality of transactions performed by the clients;
means for verifying that the plurality of transactions conform to rules maintained at the server, wherein the rules are for examining prior operational history and current operation of the clients;
means for aggregating at the server the data on the plurality of transactions; and
means for sending the data on the plurality of transactions to a master server, wherein the master server is coupled to the server and to other servers.

25. The system of claim 24, further comprising:
means for generating an invoice based on the aggregated data on the plurality of transactions; and
means for displaying the data on the plurality of transactions to an administrator connected to the server.

26. The system of claim 24 wherein the master server has master server side applications that corresponds to server side applications on the server, the system further comprising:
means for storing the data on the plurality of transactions at the master server; and
means for displaying the data on the plurality of transactions to an administrator connected to the master server.

27. The system of claim 24 wherein the data on the plurality of transactions include billing information related to the plurality of clients, and a billing application on the server performs the aggregating, wherein the billing application on the server sends the data to a master billing application on the at least one server.

28. A system for updating clients, comprising:
a plurality of management servers;
a master server connected to the plurality of management servers;
means for receiving an update at a management server from the master server;
means for determining at the management server at least one client that requires the update, wherein the one management server manages a plurality of clients including the at least one client, wherein the management server includes rules for examining prior operational history and current operation of the at least one client, and wherein the update including code is necessary for satisfying the rules; and
means for pushing the update to the at least one client from the management server.

29. The system of claim 28, wherein the master server manages the plurality of management servers, wherein the master server is connected securely to the plurality of management servers, wherein the plurality of clients comprise a storage area network, and wherein pushing the update to the at least one client does not require permission of any user of the at least one client.

30. The system of claim 28, wherein the plurality of management servers periodically update the master server with information related to the plurality of clients managed by the plurality of management servers.

31. An article of manufacture for network management, wherein the article of manufacture is capable of causing operations, the operations comprising:
discovering information on at least one client of a plurality of clients managed by a server;
comparing the discovered information to rules related to the management of the plurality of clients, wherein the rules are for examining prior operational history and current operation of the at least one client;
based on the comparison, recognizing an update to be applied to the at least one client, wherein the update includes an executable that can be automatically installed on the at least one client; and
pushing the update to the at least one client, wherein the discovering, comparing, recognizing and pushing are controlled by the server.

32. The article of manufacture of claim 31 wherein the discovering is performed by a discovery application on the server, wherein the discovering further comprises:
determining a unique name of the at least one client;
determining an operating system of the at least one client; and
determining a participation in a dynamic licensing scheme of the at least one client.

33. The article of manufacture of claim 31 wherein the comparing and recognizing is performed by an analysis application on the server, and wherein the rules related to the management of the plurality of clients include rules related to versioning requirements of software, rules related to network environment, rules related to billing, rules related to analysis of logs, and rules related to licensing requirements.

34. The article of manufacture of claim 31, wherein the server includes an user interface application, the article of manufacture further comprising:
prior to pushing, displaying a message via the user interface application on a screen of the at least one client, wherein the message is transmitted in hypertext, text file format or electronic mail to the at least one client, and wherein the message requests permission from the at least one client for pushing the update.

35. The article of manufacture of claim 31, further comprising:
prior to pushing the update, receiving the update at the server from a master server, wherein the master server is a computational device to which a plurality of servers are securely connected.

36. The article of manufacture of claim 31, further comprising:
based on the comparison, determining that the at least one client cannot be managed by the server;
sending a notification to an user of the at least one client and the administrator of the server of the determination that the at least one client cannot be managed by the server; and
sending a suggested modification that would allow the at least one client to be managed by the server to the user of the at least one client.

37. The article of manufacture of claim 31, wherein the discovering, comparing, recognizing, and pushing are performed by a server side application on the server, wherein the server side application comprises of:
a discovery application for performing discovery functions related to the plurality of clients;
an analysis application for performing validity checks with respect to the rules for the plurality of clients; and
an user interface application to control a display of information on the plurality of clients;

38. The article of manufacture of claim 31, wherein the server is connected to a storage area network, and wherein the plurality of clients include hosts and storage devices.

39. An article of manufacture for aggregating transactions, wherein the article of manufacture is capable of causing operations, the operations comprising:
receiving at a server data on a plurality of transactions performed by clients managed to the server;
verifying that the plurality of transactions conform to rules maintained at the server, wherein the rules are for examining prior operational history and current operation of the clients;
aggregating at the server the data on the plurality of transactions; and
sending the data on the plurality of transactions to a master server coupled to the server, wherein the master server is a computational device coupled to a plurality of servers.

40. The article of manufacture of claim 39, further comprising:
generating an invoice based on the aggregated data on the plurality of transactions; and
displaying the data on the plurality of transactions to an administrator connected to the server.

41. The article of manufacture of claim 39, wherein the master server has master server side applications that corresponds to server side applications on the server, the article of manufacture further comprising:
storing the data on the plurality of transactions at the master server; and
displaying the data on the plurality of transactions to an administrator connected to the master server.

42. The article of manufacture of claim 39, wherein the data on the plurality of transactions include billing information related to the plurality of clients, and a billing application on the server performs the aggregating, wherein the billing application on the server sends the data to a master billing application on the at least one server.

43. An article of manufacture for updating devices, wherein the article of manufacture is capable of causing operations, the operations comprising:
receiving an update at a management server from a master server connected to the management server, wherein a plurality of management servers are connected to the master server;
determining at the management server at least one client that requires the update, wherein the one management server manages a plurality of clients including the at least one client, wherein the management server includes rules for examining prior operational history and current operation of the at least one client, and wherein the update including code is necessary for satisfying the rules; and
pushing the update to the at least one client from the management server.

44. The article of manufacture of claim 43, wherein the master server manages the plurality of management servers, wherein the master server is connected securely to the plurality of management servers, wherein the plurality of clients comprise a storage area network, and wherein pushing the update to the at least one client does not require permission of any user of the at least one client.

45. The article of manufacture of claim 43, wherein the plurality of management servers periodically update the master server with information related to the plurality of clients managed by the plurality of management servers.
